(19) United States
(12) Patent Application Publication
(10) Pub. No.: US 2024/0001515 A1
(43) Pub. Date: Jan. 4, 2024

(54) QUICK CONNECTOR

(71) Applicant: AFFINITY TOOL WORKS, LLC, Troy, MI (US)

(72) Inventors: Mike URSELL, Bloomfield Hills, MI (US); Alex MORCK, Clarkston, MI (US); Ken NEILSON, Rochester Hills, MI (US); Connor URSELL, Bloomfield Hills, MI (US); David THIMM, Plymouth, MI (US); David WILSON, Kimball, MI (US); Grey PARKER, West Bloomfield, MI (US); Emanuel SZUMER, Sydney (AU); Will Koederitz, Royal Oak, MI (US)

(21) Appl. No.: 18/216,451

(22) Filed: Jun. 29, 2023

Related U.S. Application Data
(60) Provisional application No. 63/356,994, filed on Jun. 29, 2022.
(60) Provisional application No. 63/521,872, filed on Jun. 19, 2023.

(51) Int. Cl. B25B 5/08; B25B 5/02; B25B 5/16

(52) U.S. Cl. CPC B25B 5/085; B25B 5/02; B25B 5/166

(57) ABSTRACT

A quick connector for connecting two sections together. The sections have a first end and a second end. A body member is configured to be mounted to the first section at the first end. The body member partially extends from the first end and is configured for insertion into the second end of the second section. A locking member is mounted for movement with respect to the body member between a locked and unlocked position. The locking member engages the second section when in the locked position locking the first and second sections together, the locking member disengages from the second section when in the unlocked position unlocking the first and second sections.

### RELATED APPLICATIONS

This application claims the benefit of U.S. Provisional Application Nos. 63/356,994 filed on Jun. 29, 2022, and 63/521,872 filed on Jun. 19, 2023, which are incorporated herein by reference in their entirety.

### TECHNICAL FIELD

This invention relates generally to the connections of sections particularly to sections that form a straight edge and more particularly to quick connects for connecting sections of a straight edge clamp together.

### BACKGROUND OF THE INVENTION

It is desirable to connect sections together quickly and securely to form a tool of desired length. This is particularly important for connecting sections of a straight edge clamp. Straight edge clamps are well known for use in making straight cuts with for example a circular saw, or for guiding a router on materials, such as wood, aluminum plastic, etc. Straight edge clamps provide a straight edge secured to a work piece or work pieces so that a power tool or a guide for a power tool can be moved along the straight edge, for example, to form a cut edge with a circular hand saw or to form a trimmed edge with a hand router. Also, straight edge clamps are used for the purpose of holding accessory tool against a work piece, for example, to form pocket holes.

Examples of a straight edge clamps are disclosed in U.S. Pat. Nos. 9,815,177, 10,487,947; and 10,987,782 assigned to the assignee of the present invention. By way of example, the '177 patent has all clamping movements controlled at a single end of the clamp which reduces the cost of the clamp and greatly simplifies operation of the clamp.

The straight edge clamp permits the length of the straight edge to be easily changed by the attachment or removal of sections. The straight edge clamp includes an elongated body, a clamping head assembly and an end stop. The elongated body includes a single section or if desired two or more sections and a connector for connecting the sections to form the elongated body. It should be appreciated by those of ordinary skill in the art that the number of sections that are connected determines the length of the straight edge clamp. Any number of sections can be connected.

The length of the sections can be any length, such as for example approximately two feet in length and can be attached to form two, four, six, eight, ten, twelve feet, etc., straight edge clamps. The section lengths can be any other length if desired. This is beneficial since it allows a user to purchase the number of sections to form the desired length of the straight edge clamp. This also alleviates the need for the user to have a number of straight edge clamps for different jobs as is required with conventional straight edge clamps. With the straight edge clamp of the present invention, the user merely attaches the sections together to obtain the desired length.

Another benefit of the sections is the straight edge clamp is easier and less costly to ship than conventional straight edge clamps since it can be packaged in a small package, the general size of the sections. A still further benefit of the sections is that it is easier to display at the point of purchase when compared to conventional straight edge clamps.

In use, the bottom of the elongated body is adapted to be positioned against a work surface. The work surface has sides and the clamping head assembly and end stop are adapted to be positioned against the sides. Once positioned, the head clamping assembly is moved to the clamped position or in the alternative embodiment, both the head clamping assembly and end stop are moved to the clamping position.

The sections of the prior art are connected by the insertion of a connector between the sections. The connector is typically friction fit in the channels of the sections. These work, but what is needed is a quick connect that not only connects the sections but does so quickly and securely. One that locks the sections together. What is needed is a positive, quick, and secure connection between the sections.

### SUMMARY OF THE INVENTION

In general terms, this invention provides a quick, positive, and secure locking connector to connect the sections of a straight edge, and in particular a straight edge clamp.

The present invention is a quick connector for connecting two sections together. The sections have a first end and a second end. A body member is configured to be mounted to the first section at the first end, the body member partially extends from the first end and is configured for insertion into the second end of the second section. A locking member is mounted for movement with respect to the body member between a locked and unlocked position. The locking member engages the second section when in the locked position locking the first and second sections together, the locking member disengages from the second section when in the unlocked position unlocking the first and second sections.

These and other features and advantages of this invention will become more apparent to those skilled in the art from the detailed description of preferred embodiments. The drawings that accompany the detailed description are described below.

### BRIEF DESCRIPTION OF THE DRAWINGS

FIG. 1 is an exploded perspective view of the quick connect of the present invention.

FIG. 2 is a perspective view of the quick connect in the locked position.

FIG. 3 is a perspective view of the quick connect in the unlocked position.

FIG. 4 is a bottom partial perspective view.

FIG. 5 is a sectional view.

FIG. 6 is an exploded view of a second embodiment of the straight edge quick connect of the present invention.

FIG. 7 is a perspective view of the second embodiment of the straight edge quick connect in the open position.

FIG. 8 is a perspective view of the second embodiment of the straight edge quick connect in the closed position.

FIG. 9 is a perspective view of the second embodiment of the straight edge quick connect in the open position mounted in a straight edge.

FIG. 10 is a perspective view of the second embodiment of the straight edge quick connect in the closed position mounted in a straight edge.

FIG. 11 is a perspective view of the bottom of the second embodiment of the straight edge quick connect mounted in a straight edge.

### DETAILED DESCRIPTION OF A PREFERRED EMBODIMENT

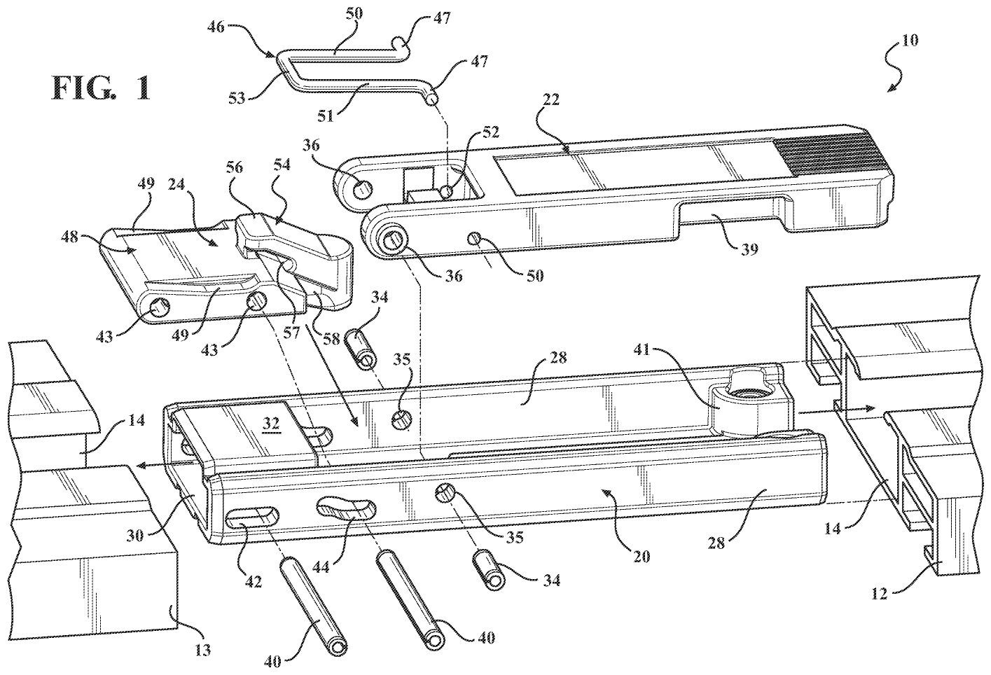

The first embodiment of the section connector of the present invention is shown generally at 10 in the FIGS. 1 through 5. The connector 10 connects two sections 12 and 13 together to form a longer straight edge clamp. Additional sections can be connected to form a straight edge of any desired length. It will be understood by those ordinary skill in the art, that there could be several sections which when connected form a straight edge of a desired length.

Each section 12 and 13, has channels 14 into which connector 10 can be inserted. In the disclosed embodiment, fasteners 16 (shown as screws) connect the proximal side of connector 10 to section 12 (See FIG. 4). The distal end of connector 10 is exposed and protrudes from section 12 for insertion into a section 13 for clamping the two sections 12 and 13 together, as will be described below.

The connector 10 has a main connector body or body member 20, a locking handle 22, and a locking member 24. As disclosed, the main connector body 20 is generally U-shaped with sides 28 and a bottom 30. A guide section 32 covers the distal end of connector 10. This guide section 32 facilitates guiding section connector 10 into the section 13 and adds stability and support to the locking member 24. It should be appreciated by those of ordinary skill in the art that the locking member could be moved between the locked and unlocked positions without the handle 22, obviating the need for the handle 22.

As illustrated, the locking handle 22 is mounted for pivotal movement with respect to connector 10. It should be appreciated by those of ordinary skill in the art that the locking handle 22 could be mounted for rotational movement as opposed to pivotal movement by mounting the locking handle to a pivot axis extending from the body member. The locking handle is joined to the sides of connector body 20 by pivot pins 34. The pins 34 are inserted into openings 35 located in the sides 28 in main connector body 20 and apertures 36 located in the proximate end 37 of the locking handle 22. The locking handle 22 when connected by pivot pins 34 is free to pivot between raised and lowered positions with respect to the connector 10. The locking handle 22 as disclosed, includes recessed sections 39, which align with bosses 41 formed in the section connector 20. Bosses 41 receive the fasteners 16 for connecting member 20 to section 12. The locking handle is held down by the link 53 being over center. The base of the link 53 is higher than the ears 47 when locking handle 22 is down and locked.

Mounting rods or pins 40 connect the locking member 24 to the connector body 20. As illustrated, there are a pair of slots 42 and 44 in each of the sides 28 of connector body 20 for receipt of the rods 40. The rods 40 are inserted in two openings 43 in the locking member 24 and extend through the locking member 24 and into the adjacent opposed slots 42 and 44 in the connector body 20. The slots 42 and 44 allow the blocking member 24 to slide with respect to connector body 20 to raise and lower with respect to connector body 20 because of the locking handle 22 being raised or lowered with respect to connector body 20. As illustrated, slots 42 are oblong and generally parallel with the walls 28. Slots 44 are curved. This design stabilizes the locking member 24 and allows front and back movement with respect to connector body 20 and a rocking or pivoting movement from raised to lowered.

A connector clip or link 46 interconnects and controls the movement between the locking handle 22 and the locking member 24. It will be appreciated by those of ordinary skill in the art that other connector clips or links 46 could be used instead of the illustrated connecting clip 46, such as for example, a single shaft, bar, or two separate shafts or bars, etc. As illustrated, connecting clip 46 is generally U-shaped with a pair of arms 51 and a base 53. The connecting clip 46 has ears 47 that are received within apertures 50 and 52 formed in the locking handle 22.

As illustrated in the figures, the locking member 24 as a main locking member body 48, a head portion, 54 and an engagement finger 56. The body 48 of locking member 24 is illustrated with recesses 49 that engage the guide section 32 to provide stability and alignment of locking member 24 within main body 20 of connector section 10.

The base 53 of clip 46 is received under the finger portion 56 of locking member 24. The underside of finger portion 56 has a recess 57 that receives and guides the base 53 of connecting clip 46 as it reciprocates with respect to head portion 54 as the locking handle 22 is raised and lowered. The reciprocation of the connecting clip 46 results in the locking member 24 sliding with respect to the connector body 20.

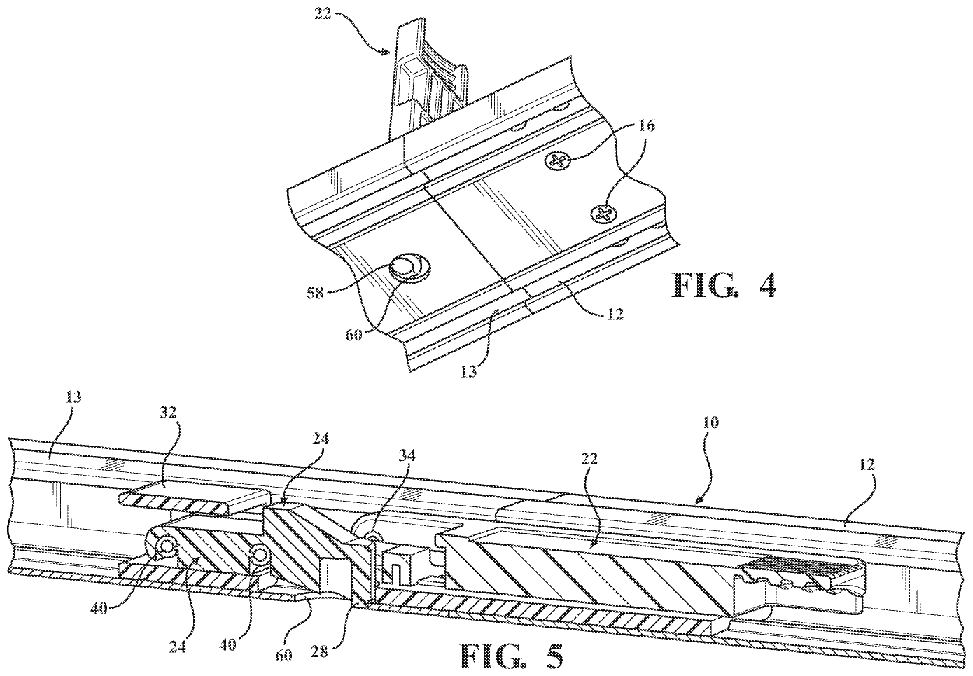

The head portion 54 includes a protrusion 58 which engages with an opening 60 in the section 13, as better illustrated in FIGS. 4 and 5. When clamping the sections 12 and 13 together, the locking member 24 slides within connector body 20 in the direction of section 12 and the head portion 54 and protrusion 58 lower for engagement of protrusion 58 within opening 60 to secure and lock the two sections 12 and 13 together.

In use, section 12 has the section connector 10 mounted within it. As illustrated, it's mounted with fasteners 16, but could for example be press fit, glued, or friction fit within section 12. The desired connection of the section connector 10 within section 12 depends upon whether it is intended for the connector 10 to be removed from the section 12.

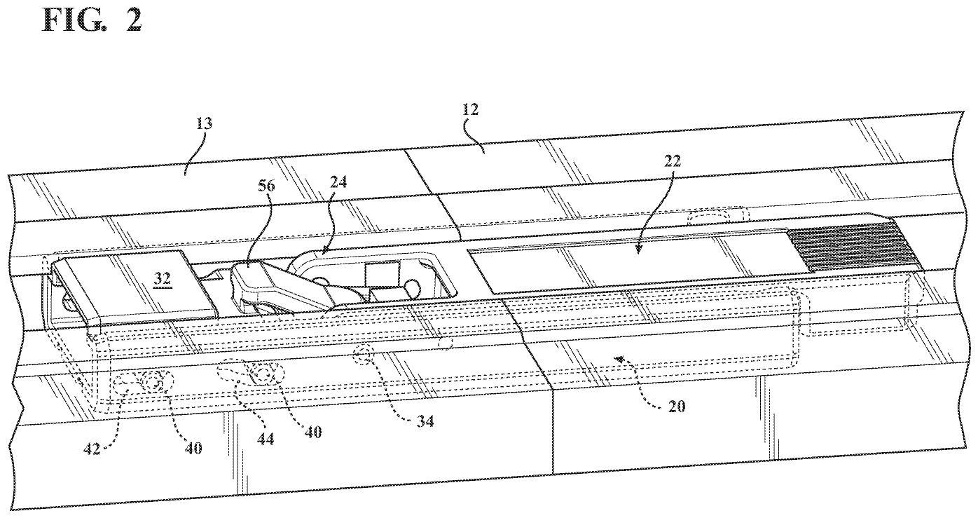

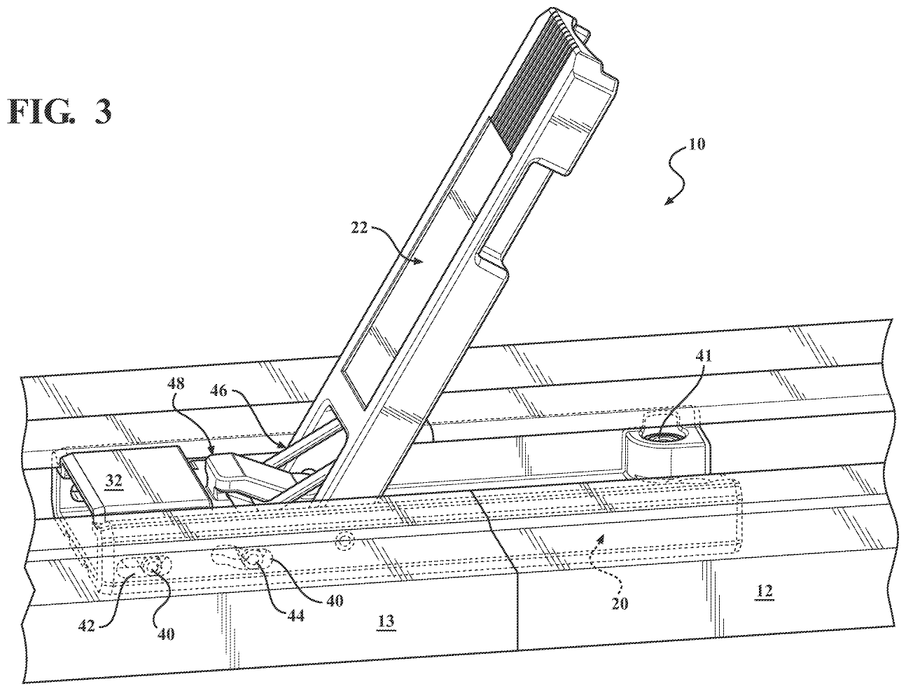

The distal end of the locking member 24 protrudes from the section 12 for insertion into section 13. When joining of the sections is desired, the distal end of the connector body 20 is inserted into the channel 14 of section 13 until the facing ends of the two sections 12 and 13 engage. This is done with the locking handle 22 in the raise position as shown in FIG. 3. Once the two sections are joined, the locking handle 22 is lowered as shown in FIG. 2, which results in the two sections 12 and 13 being locked due to the protrusion 58 on head portion 54 entering the opening 60 and being retained in that position. The protrusion 58 enters and engages the opening 60 because of the locking handle 22 being rotated with respect to the connector body 20 and lowered which causes the connecting clip 46 to pull the locking member 24 in the direction of section 12 while simultaneously lowering the locking member 24 with respect to section 13. The lowering of locking member 24 with respect to section 13 causes the protrusion 58 to enter opening 60 to lock the two sections 12 and 13 together. To unlock and separate the sections 12 and 13, the handle 22 is raised, which moves and raises the locking member 24 which causes the protrusion 58 to raise out of the opening 60 and unlock the sections. The sections can then be pulled apart. It should be appreciated by those of ordinary skill in the art that a detent or similar engagement could be used instead of the opening 60 and protrusion 58 and opening 60 and protrusion 58 could also be reversed.

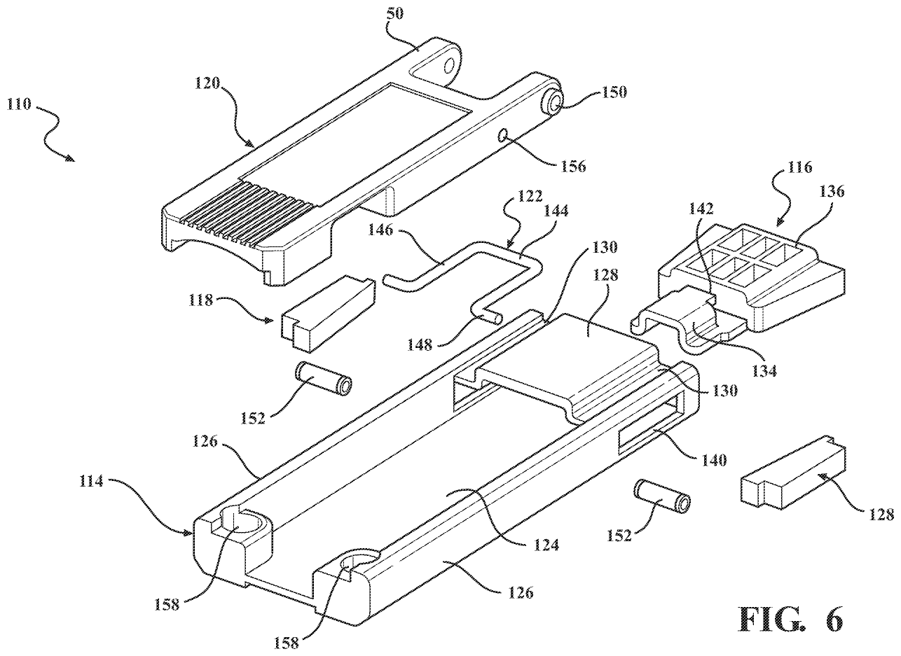

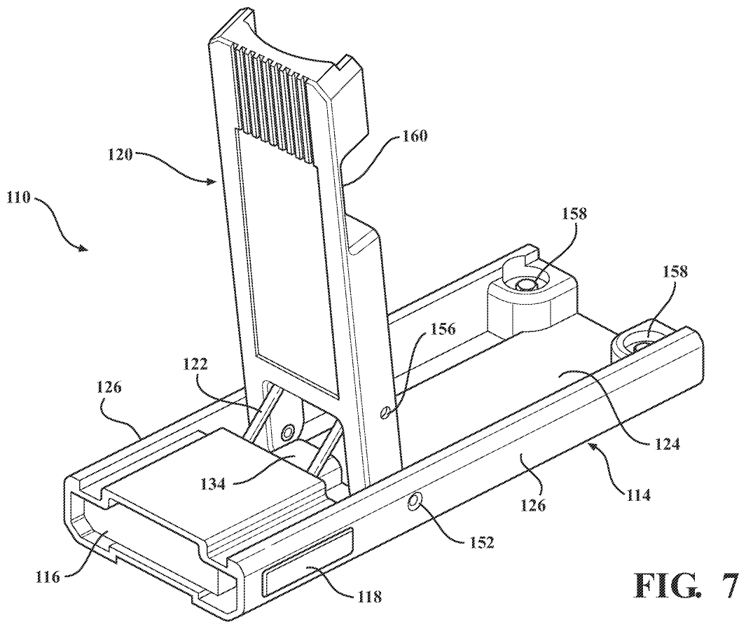

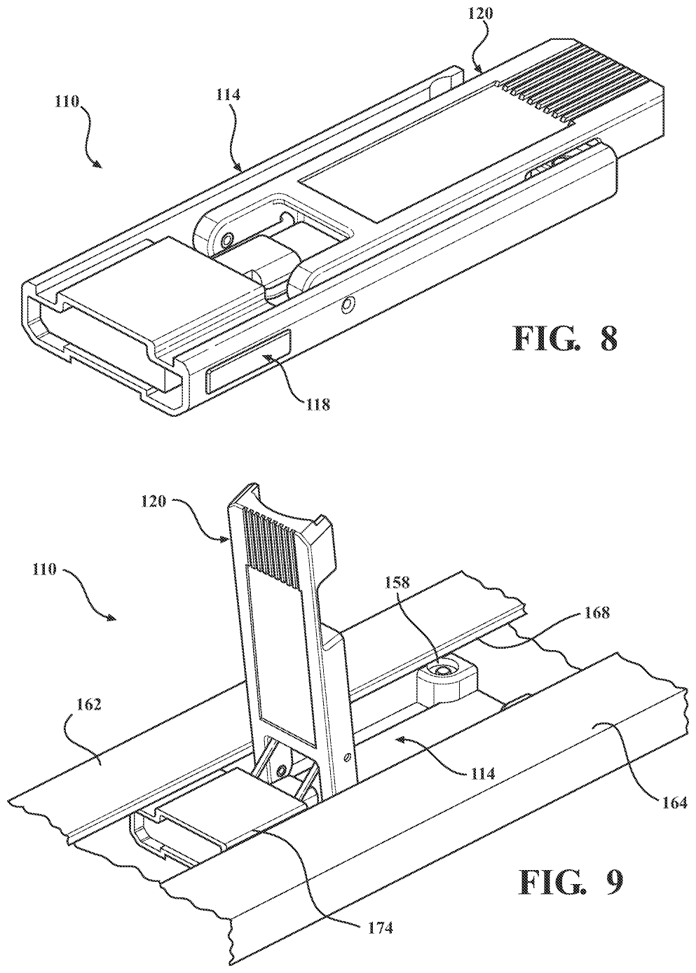

In FIGS. 6 to 11, a second embodiment is shown generally at 110. The quick connect 110 is used to connect sections of a straight edge together to increase the length of the straight edge. The quick connect allows the straight edge sections to be quickly, accurately, and securely connected.

With reference to FIG. 6, the quick connect of the present invention is shown generally at 110. It includes a main body support 114 that houses a locking member defined by a driving wedge 116 and adjacent driven wedges 118. It should be understood by those of ordinary skill in the art that a single driven wedge 118 could be used, instead of two driven wedges 118 as illustrated.

A locking handle 120 is connected to the main body support 114 and to the driving wedge 116 by a link 122. The handle 120 pivots with respect to the main body support 114 to move the link 122 and reciprocate the driving wedge 116 within the main body support 114. It should be appreciated by those of ordinary skill in the art that the driving wedge 116 could be moved without the handle 120 between the locked and unlocked positions, obviating the need the handle 120. It should be appreciated by those of ordinary skill in the art that the locking handle 120 could be mounted for rotational movement as opposed to pivotal movement by mounting the locking handle 120 to a pivot axis extending from the body member 114.

The driving wedge 116 engages the driven wedges 118 to force them out of the main body support 114 to engage the section and lock the section in position. As will be described below, the link 122 locks the adjacent sections 162 and 164 together.

The main body support 114 has a bottom 124 and side walls 126. A cover 128 covers a portion of the main body support 114. The cover 128 has parallel grooves 130 that receive the downwardly extending lips 168 of a section 162 to facilitate proper alignment. A pair of slots or openings 140 are formed in the sidewalls 126 for receipt of the driven wedges 118.

With reference to FIG. 6, the driving wedge 116 in the disclosed embodiment has a stamped steel wedge 134 and a molded driving wedge 136. A catch 142 is provided on the stamped steel wedge that receives the link 122. It will be appreciated by one of ordinary skill in the art that the driving wedge 116 could be a single piece of steel, hard rubber, plastic, or reinforced plastic for example.

The link 122 is disclosed as a generally U-shaped member. It has a base 144 that is received by the catch 142. Legs 146 extend from the base 144 and terminate in outwardly extending ears 148. The ears 148 are received within holes 156 in the locking handle 120. It will be appreciated by one of ordinary skill in the art that the link 122 could be two separate arms with each directly mounted to the locking handle 120 and the driving wedge 116 or a single member for example.

As disclosed, pins 152 extend through the sides wall 126 and into openings 150 in the locking handle 120. The locking handle 120 pivots about the pins 152 or in the alternative the pins 152 can rotate within the openings 150. It will be appreciated by one of ordinary skill in the art that other pivoting connections between the locking handle 120 and the main body support 114 could be used, such as for example live hinge or a hinge mounted to the base 124 and handle 120.

Mounting bosses 158 are provided for mounting the main body support 114 to the section 164. As shown in FIG. 6, fasteners 172 extend from the bottom of the section 164 into the mounting bosses 158. The fasteners 172 as illustrated are countersunk so that they are flush with the bottom of section 164. It will be appreciated by one of ordinary skill in the art that other mounting methods could be used, for example, the main body support 114 could be glued or welded into the section 164. As disclosed in FIG. 6, there are guides 170 on the sections 162 and 164 that are received within bottom grooves 171 in the bottom of the main body support 114 to facilitate proper alignment.

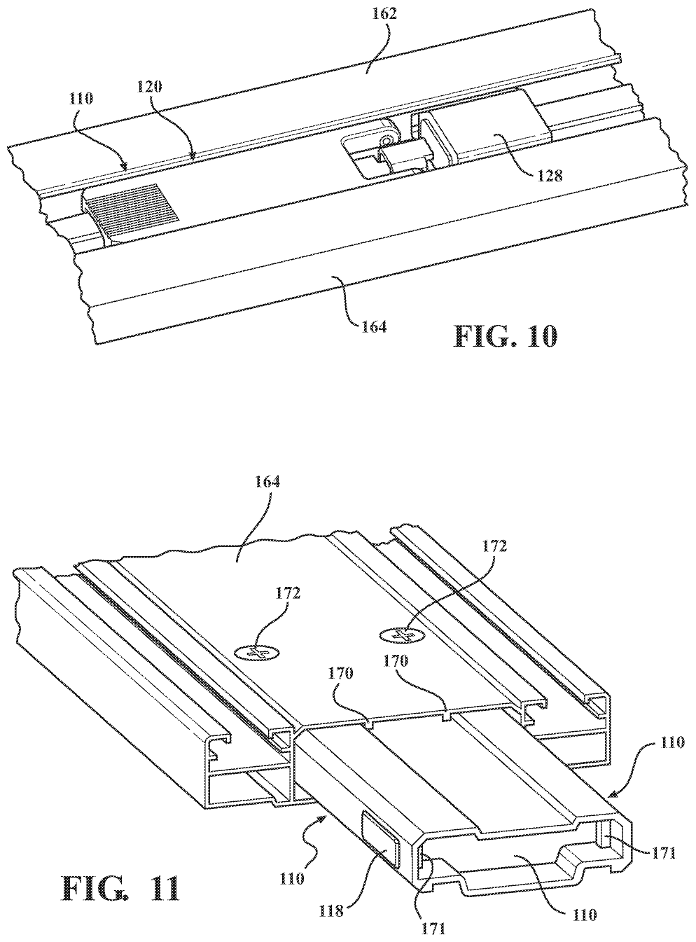

With reference to FIGS. 9 and 10, the operation of the quick connect 110 of the present invention will be described. The main body support 114 of quick connect 110 is attached to section 164 and is designed to quickly connect an adjacent section 162 to the section 164. The main body support 114 is shown bolted to the section 164. The section 162 is slid onto the exposed portion 174 of it the quick connect 110. The exposed portion has grooves 30 that receive the lips 168 on the section 162 profile. There are also guides 170 on the underside of the section 164 (see FIG. 11), that are received in bottom grooves 171 on the underside of the main body support 114 to facilitate alignment of the section 162 with respect to the quick connect 110 and the section 164. The locking handle 120 is in the raised position as shown in FIG. 4.

Once the section 162 abuts section 164 the handle 120 is lowered (see FIG. 10) which pulls the driving wedge 116 towards the section 164. The driven wedges 118 are forced outwardly by the driving wedge 116 to engage the section 162 locking that section in place with respect to the section 164.

It will be appreciated that several sections can be added to obtain the desired length of the straight edge.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A connector for a straight edge comprising:
a straight edge having first and second sections to be connected, each of said sections having a first end and a second end;
a body member configured to be mounted to said first section at said first end, said body member partially extending from said first end and configured for insertion into said second end of said second section;
a handle connected to said body for movement with respect to said body;
a locking member mounted for movement with respect to said body member between a locked and unlocked position;
a link connecting said handle to said locking member, said handle moving said locking member between said locked and unlocked positions;
said handle moving said locking member to engage said second section when in said locked position locking said first and second sections together, said handle moving said locking member to disengage said second section when in said unlocked position unlocking said first and second sections.

2. The connector of claim 1, wherein said body member includes a base and sides, with said locking member sliding within said sides.

3. The connector of claim 2, wherein said locking member is retained within said body member for sliding movement and rocking movement.

4. The connector of claim 1, wherein said body member and locking member are interconnected with slots and pins.

5. The connector of claim 4, wherein said body member includes first and second slots and said locking member includes first and second bores configured to receive first and second pins.

6. The connector of claim 5, wherein said first slot is straight and said second slot is offset to allow said locking member to slide and pivot with respect to said body member.

7. The connector of claim 6, wherein said locking member includes a first engagement member configured to engage said section and lock said locking member with respect to said second section and lock said first and second sections together.

8. The connector of claim 7, wherein said second section includes a second engagement member, said first engagement member engaging said second engagement member to lock said first and second sections together.

9. The connector of claim 8, wherein said locking member slides and pivots with respect to said body member and said second section to engage said first engagement member with said second engagement section to lock said sections together.

10. The connector of claim 1, wherein said locking member includes a driving wedge and at least one adjacent driven wedge, said driving wedge is configured to drive said driven wedge into said second section to lock said first section to said second section.

11. The connector of claim 10, wherein said driving wedge includes a catch for interconnecting said link with said driving wedge.

12. The connector of claim 10 wherein said body member includes at least one slot for receipt of said driven wedge.

13. The connector of claim 12, wherein said second section includes a wall adjacent said at least one slot, said driven wedge being configured to engage said wall.

14. The connector of claim 1, wherein said locking member includes a head portion with a finger, said link engaging said finger to interconnect said handle and said locking member.

15. The connector of claim 1, wherein said locking member includes a protrusion configured to engage said section and lock said locking with respect to said second section and lock said first and second sections together.

16. The connector of claim 1, wherein said handle is configured to pivot with respect to said body member to move said locking member between said locked and unlocked positions.

17. The connector of claim 1, wherein said straight edge includes a plurality of pairs of sections and a plurality of connectors to connect pairs of sections together.

18. A quick connect configured to connect first and second sections together comprising:
a main body,
a locking member configured to move with respect to said main body between locked and unlocked positions;
said locking member configured to engage the sections when locked and disengage from said section to unlock said sections.

19. The connector of claim 18, wherein said locking member is retained within said body member for sliding movement and rocking movement.

20. The connector of claim 18, wherein said body member and locking member are interconnected with slots and pins.

21. The connector of claim 18, wherein said body member includes first and second slots and said locking member includes first and second bores configured to receive first and second pins.

22. The connector of claim 21, wherein said first slot is straight and said second slot is offset to allow said locking member to slide and pivot with respect to said body member.

23. The connector of claim 22, wherein said locking member includes a first engagement member configured to engage said section and lock said locking member with respect to said second section and lock said first and second sections together.

24. The connector of claim 23, wherein said second section includes a second engagement member, said first engagement member engaging said second engagement member to lock said first and second sections together.

25. The connector of claim 24, wherein said locking member slides and pivots with respect to said body member and said second section to engage said first engagement member with said second engagement section to lock said sections together.

26. The connector of claim 18, wherein said locking member includes a driving wedge and at least one adjacent driven wedge, said driving wedge is configured to drive said driven wedge into said second section to lock said first section to said second section.

27. The connector of claim 26, further including a locking handle and a link, said driving wedge includes a catch for interconnecting said link and locking handle to said driving wedge.

28. The connector of claim 10 wherein said body member includes at least one slot for receipt of said driven wedge.

29. The connector of claim 28, wherein said second section includes a wall adjacent said at least one slot, said driven wedge being configured to engage said wall.

30. The connector of claim 18, wherein said locking member includes a head portion with a finger, said link engaging said finger to interconnect said handle and said locking member.

31. The connector of claim 18, wherein said locking member includes a protrusion configured to engage said section and lock said locking member with respect to said second section and lock said first and second sections together.

32. The connector of claim 18, further including a handle configured to pivot with respect to said body member to move said locking member between said locked and unlocked positions.

33. The connector of claim 18, further including a plurality of pairs of sections and a plurality of connectors to connect pairs of sections together.

34. A connector for a straight edge clamp comprising:
a straight edge clamp having clamps for attaching said straight edge clamp to a worksurface, said straight edge clamp having first and second sections to be connected, each of said sections having a first end and a second end;
a body member configured to be mounted to said first section at said first end, said body partially extending from said first end and configured for insertion into said second end of said second section;
a handle connected to said body for movement with respect to said body;
a locking member mounted for movement with respect to said body member between a locked and unlocked position;
a link connecting said handle to said locking member, said handle moving said locking member between said locked and unlocked positions;
said handle moving said locking member to engage said second section when in said locked position locking said first and second sections together, said handle moving said locking member to disengage said second section when in said unlocked position unlocking said first and second sections.

35. The connector of claim 34, wherein said locking member is retained within said body member for sliding movement and rocking movement.

36. The connector of claim 34, wherein said body member and locking member are interconnected with slots and pins.

37. The connector of claim 36, wherein said body member includes first and second slots and said locking member includes first and second bores configured to receive first and second pins.

38. The connector of claim 37, wherein said first slot is straight and said second slot is offset to allow said locking member to slide and pivot with respect to said body member.

39. The connector of claim 38, wherein said locking member includes a first engagement member configured to engage said section and lock said locking member with respect to said second section and lock said first and second sections together.

40. The connector of claim 39, wherein said second section includes a second engagement member, said first engagement member engaging said second engagement member to lock said first and second sections together.

41. The connector of claim 38, wherein said locking member slides and pivots with respect to said body member and said second section to engage said first engagement member with said second engagement section to lock said sections together.

42. The connector of claim 34, wherein said locking member includes a driving wedge and at least one adjacent driven wedge, said driving wedge is configured to drive said driven wedge into said second section to lock said first section to said second section.

43. The connector of claim 42, wherein said driving wedge includes a catch for interconnecting said link with said driving wedge.

44. The connector of claim 43 wherein said body member includes at least one slot for receipt of said driven wedge.

45. The connector of claim 44, wherein said second section includes a wall adjacent said at least one slot, said driven wedge being configured to engage said wall.

46. The connector of claim 34, wherein said locking member includes a head portion with a finger, said link engaging said finger to interconnect said handle and said locking member.

47. The connector of claim 34, wherein said locking member includes a protrusion configured to engage said section and lock said locking member with respect to said second section and lock said first and second sections together.

48. The connector of claim 34, wherein said handle is configured to pivot with respect to said body member to move said locking member between said locked and unlocked positions.

49. The connector of claim 34, wherein said straight edge clamp includes a plurality of pairs of sections and a plurality of connectors to connect pairs of sections together.
